(19) United States
(12) Patent Application Publication
(10) Pub. No.: US 2012/0208419 A1
(43) Pub. Date: Aug. 16, 2012

(54) PROCESS FOR PRODUCING SEMIFINISHED FIBER MATERIAL

(76) Inventor: Henrik DOMMES, Bremen (DE)

(21) Appl. No.: 13/372,897

(22) Filed: Feb. 14, 2012

(30) Foreign Application Priority Data
Feb. 14, 2011 (DE) 10 2011 000 722.9

(51) Int. Cl. D04H 13/00; B27N 3/04

(52) U.S. Cl. 442/327; 428/292.1; 156/62.2; 156/436

(57) ABSTRACT

A process for producing semifinished fiber material with oriented fibers, in which a flat carrier material (14) is provided, in which fibers are deposited aligned on the carrier material (14), and in which the fibers are fixed to the carrier material (14). A high-quality semifinished fiber material can be provided in a simple and cost-effective manner by a fluid-permeable carrier material made of a thermoplastic being used as the carrier material (14).

### CROSS REFERENCE TO RELATED APPLICATIONS

This application claims the benefit of priority under 35 U.S.C. §119 of German Patent Application DE 10 2011 000 722.9 filed Feb. 14, 2011, the entire contents of which are incorporated herein by reference.

### FIELD OF THE INVENTION

The present invention pertains to a process for producing semifinished fiber material with oriented fibers, in which a flat carrier material is provided, in which fibers are deposited aligned on the carrier material and in which the fibers are fixed to the carrier material.

### BACKGROUND OF THE INVENTION

Such a process is known from DE 10 2008 048 334 A1. The drawback in this case is that the prior-art process is not suitable for the production of fiber-reinforced plastics with a duroplastic matrix. In particular, a thermoplastic matrix is used in the prior-art process. However, fiber-reinforced plastics with a duroplastic matrix can be used more flexibly in the production of components and, moreover, yield a higher strength. In the use of a duroplastic matrix, however, the problem arises that a fabric or mat is required for an alignment of the fibers with the good strength values resulting therefrom. This leads to considerably higher costs of the fiber material. Thus, the costs of fabrics or mats are usually approx. five times higher than the costs of rovings. Moreover, the waste of the fiber fabric or fiber mat used, which forms during the wet lamination method for duroplastics, usually cannot be further utilized. Rather, this waste must usually be disposed of at a high cost.

### SUMMARY OF THE INVENTION

Hence, a basic object of the present invention is to provide a process for producing semifinished fiber material, with which a semifinished fiber material with oriented fibers for use with a duroplastic matrix can be produced in a simple and cost-effective manner.

The object is accomplished by a fluid-permeable carrier material made of thermoplastic being used as the carrier material in a process of the type mentioned in the introduction.

Fibers oriented in the known manner can be fixed to this fluid-permeable fiber material. In this way, a flat fiber material with oriented fibers, similar to a fabric or mat, can be provided as semifinished fiber material, which can be stored for a fairly long time and, if necessary, can be impregnated in the known manner with a duroplastic matrix.

A variant of the present invention is characterized in that the carrier material is a nonwoven fabric, mat or fabric, which is especially made of polypropylene or polyamide. The oriented fibers can be deposited in the known manner on such a nonwoven fabric, mat or fabric. If a carrier material made of a thermoplastic is used, then the fibers can be fixed to the carrier material by means of a suitable compressed section. However, it is also possible to extrude the carrier material immediately before depositing the oriented fibers thereon, such that the carrier material is still partly in the melted state. Polypropylene or polyamide are suitable as a simple-to-use and cost-effective carrier material.

Another exemplary embodiment is characterized in that carbon fibers are used as fibers, which are preferably arranged edge to edge and overlap by a predetermined extent especially in the fiber direction. Carbon fibers are characterized by especially high strength. With an arrangement edge to edge and especially with a predetermined overlapping in the fiber direction, good strength values can also be obtained with relatively short fibers.

One embodiment of the present invention is characterized in that alignment of the fibers is carried out by means of a vibration conveyor which has especially an upwards oriented vibration conveying path. By means of such a vibration conveyor, a distribution and alignment of the fibers for the flat sending (transport) of the carrier material with oriented fibers is possible, on the one hand. When, moreover, the conveying path is oriented upwards, a state, in which only one layer of fibers is conveyed, and successive fibers are each arranged edge to edge, is brought about by means of the suitable process parameters of the length of the conveying path, pitch angle and quantity sent. Excess fiber material in layers lying one above the other is moved downwards against the conveying direction by its own gravity.

In the present invention, it is advantageous when aligned fibers are conveyed as a flat arrangement to the carrier material by means of a conveyor belt and/or deposited on same, whereby a vacuum is applied to the conveyor belt for the nonslip conveying of the fibers, which preferably decreases in the conveying direction, especially down to ambient pressure. This conveyor belt, to which vacuum is applied, makes sure that the fibers, once they have been aligned, remain in this alignment and in the flat arrangement until application to the carrier material. The fibers are drawn forward during transport on the conveyor belt by the additional application of vacuum through the conveyor belt. In this case, a greater vacuum is necessary at the beginning when applying the fibers to the conveyor belt, so that the fibers here at first maintain their desired position. On the other hand, at a later point in time downstream, vacuum is no longer necessary when applying to the carrier material. Lowering of the vacuum in this area to ambient pressure especially contributes to the fibers being able to be deposited on the carrier material in a reliable and reproducible manner.

Moreover, it is advantageous in the present invention when fibers are fixed to the carrier material by means of a double belt press, a pair of rollers, a calender, parallel compacted sheets and/or an adhesive film on the carrier material. In this way, a secure fixing on the carrier material is obtained, such that this carrier material coated with fibers can be stored in a simple manner as a semifinished product for later processing with a duroplastic matrix. The fibers in this case are fixed rigidly to the carrier material. At the same time, an impregnation of the fiber material with the duroplastic matrix material can be achieved due to the fluid-permeability of the carrier material.

In the present invention, it is especially advantageous when fibers, preferably from waste remnants of a nonwoven fabric, mat or fabric, are cut into flat pieces and especially separated, especially preferably by means of vibration. In this way, waste remnants can be utilized to produce high-quality semifinished fiber material. The use of waste remnants cut into flat pieces is especially simple and moreover produces a good semifinished fiber material.

Another aspect of the present invention pertains to a device for producing semifinished fiber material with oriented fibers, with an alignment section for aligning the fibers and with an applying section for applying oriented fibers onto a carrier material. Fiber material can be aligned especially effectively by means of this device, when the alignment section has an upwards oriented vibration conveyor.

It is advantageous when a conveyor belt for conveying the aligned fibers as a flat arrangement to the carrier material is provided, whereby the conveyor belt has a vacuum unit, which preferably applies vacuum, which decreases downstream down to ambient pressure, to the conveyor belt. As a result of this, a secure and nonslip transport of the aligned fiber material, as a flat arrangement, up to the carrier material is guaranteed.

In another embodiment, it is, moreover, advantageous when feed means are provided for feeding the carrier material, preferably from a supply, to the fibers. These feed means make possible a high process speed, such that a large quantity of carrier material can be provided with fibers in a short time.

Another embodiment of the device according to the present invention is characterized by a double belt press, a calender or a pair of rollers for fixing the fibers to the carrier material. As a result of this, the fibers can be fixed to the carrier material in a simple and reliable manner.

Moreover, it is advantageous when the device has cutting means, especially a cutting roller and/or separating means, especially by means of vibration, for the fibers. In this way, waste remnants can be utilized again to prepare such high-quality semifinished fiber materials.

Another aspect of the present invention pertains to a semifinished fiber material with oriented fibers, in which the oriented fibers are arranged on a fluid-permeable carrier material made of a thermoplastic material for providing a cost-effective semifinished fiber material in a simple manner. Such a semifinished fiber material provides oriented fibers for a high-quality and high-strength fiber-reinforced plastic, without a fabric or mat having to be used. The carrier material here may be a nonwoven fabric, mat or fabric, which is preferably made of polypropylene or polyamide. Such thermoplastic carrier materials can be produced in a simple and cost-effective manner and advantageously covered with the fibers. It has been shown that no noteworthy loss of strength by the carrier material made of a thermoplastic material results from subsequent impregnation of this semifinished fiber material with a duroplastic matrix material. It is especially advantageous when fibers made of carbon fibers, and especially from waste remnants, are used in the semifinished fiber material, preferably in the form of surface elements. Carbon fibers have high strength, which leads to an especially strong fiber-reinforced plastic. When waste remnants are used, inexpensive composite materials can be produced, such that carbon fibers can be used for less expensive components here as well.

Exemplary embodiments of the present invention are explained in detail below based on drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which the exemplary embodiment of the invention are illustrated.

### BRIEF DESCRIPTION OF THE DRAWINGS

FIG. 1 is a view of a device for producing semifinished fiber material with the features of the present invention;

FIG. 2 is a view of another device for producing semifinished fiber material with the features of the present invention; and

FIG. 3 is a schematic view of a flow chart of a process for producing semifinished fiber material as an exemplary embodiment of the present invention.

### DESCRIPTION OF THE PREFERRED EMBODIMENTS

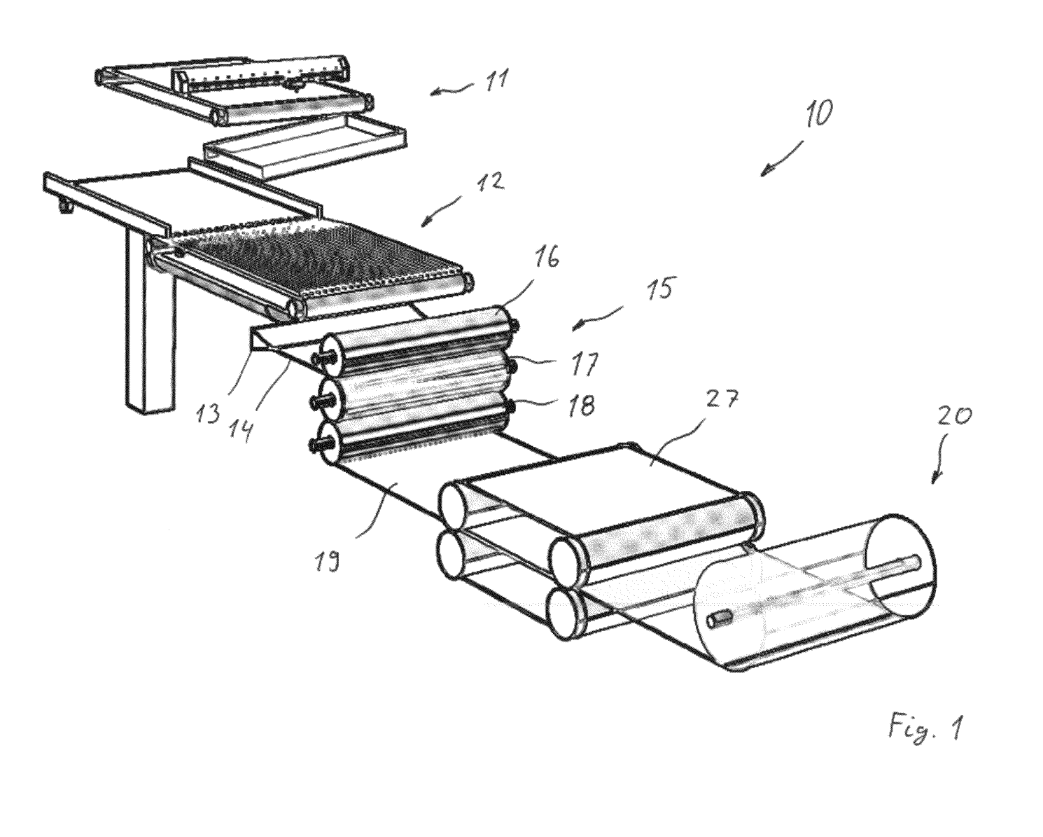

Referring to the drawings in particular, FIG. 1 shows a device 10 for producing semifinished fiber material as an exemplary embodiment of the present invention. The device 10 has a vibration conveyor 11, a vibration conveyor 12 arranged downstream thereof, an extruder 13 for producing the carrier material 14 and a compressed section 15. Compressed section 15 is formed from three heatable rollers 16, 17, 18. A compressed section 27, which is embodied as a double belt press 27 in the exemplary embodiment shown, is arranged downstream of the compressed section 15.

In the exemplary embodiment shown, the vibration conveyor 11 is used for the flat distribution of this fed fiber material. The thus distributed fiber material is fed to the vibration conveyor 12, which brings about the final alignment of the fibers. The aligned and flat-distributed fibers are assigned to the carrier material 14 produced by the extruder 13 at the downstream end of the vibration conveyor 12. Since the fluid-permeable carrier material 14 produced by extruder 13 is still in a melted state at this point in time, i.e., it has still not entirely hardened, the fibers deposited thereon already continue to adhere partly to the carrier material 14. After passing through compressed section 15, the fibers are then fixed rigidly to the carrier material 14, such that a flat semifinished fiber material, which is rolled up on a roll 20, is produced downstream of the compressed section 15 and compressed section 27.

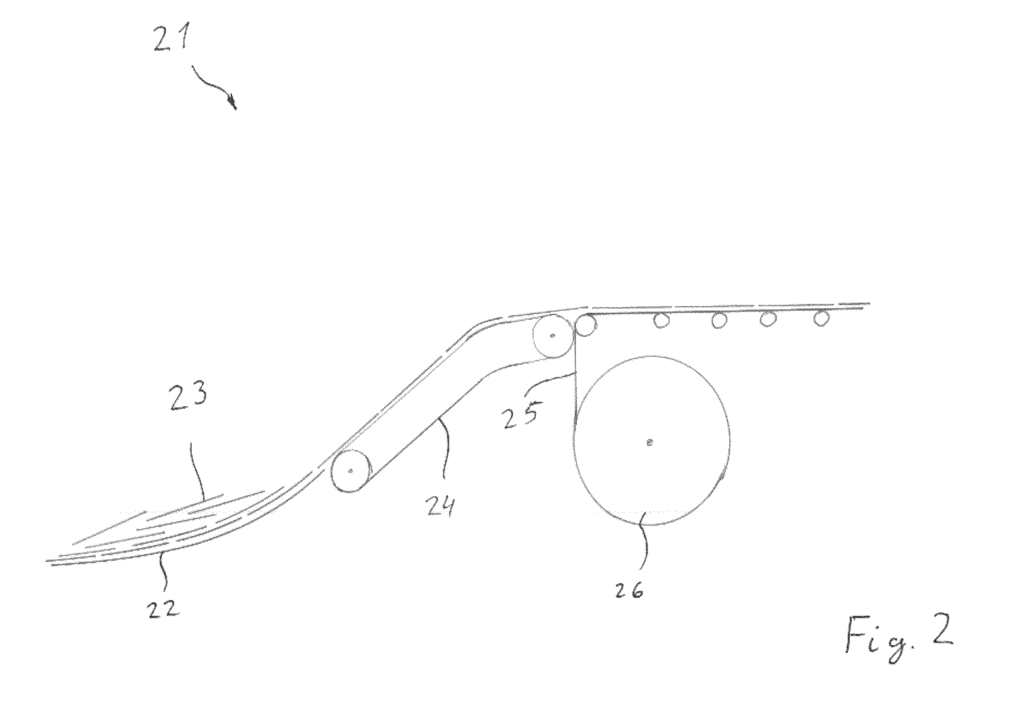

FIG. 2 shows another exemplary embodiment of a device 21 for producing semifinished fiber material with oriented fibers. In the exemplary embodiment shown, an at least partly upwards oriented conveying path of a vibration conveyor 22 is provided, to which flat fibrous elements 23 are fed. In particular, the flat fibrous elements 23 are surface elements, which have been cut out of waste remnants of a carbon fiber fabric or mat by means of a cutting roller.

A conveyor belt 24, which in the exemplary embodiment interacts with vacuum units not shown in the figure, is arranged downstream from the vibration conveyor 22. At the downstream end of the conveyor belt, a carrier material 25 is provided and continuously fed from a roll 26. The carrier material 25 is a fluid-permeable, thermoplastic nonwoven fabric material.

During the operation, the fibrous elements, with a size of approximately 10×10 cm, are strung together in a lower layer edge to edge and are positioned next to one another by the vibration conveyor 22. The fibrous elements 23 located above it slip down due to gravity against the conveying direction, such that only one layer of fibrous elements will transfer to the conveyor belt 24. It is guaranteed by the vacuum unit (not shown) that the thus arranged fibrous elements in their positioning against one another do not slip during the conveying on the conveyor belt 24. Towards a downstream end, the vacuum, which draws the fibrous elements 23 to the conveyor belt 24, decreases down to ambient pressure, such that the fibrous elements 23 at the downstream end of the conveyor belt 24 are deposited on the carrier material 25 continuously conveyed past. A compressed section (not shown), for example, by means of a pair of rollers, a calender or parallel compacted sheets, is provided in the conveying direction downstream to provide for a permanent fixing of the fibrous elements to the carrier material 25.

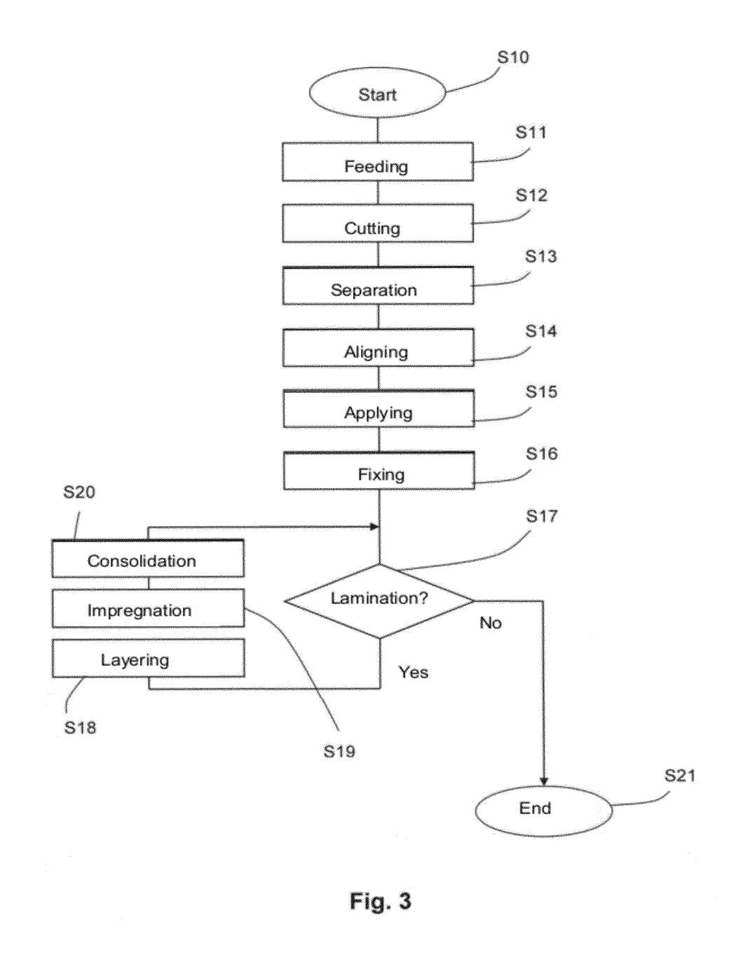

FIG. 3 shows a schematic view of a flow chart of a process for producing semifinished fiber material with the features of the present invention. First, the process is started in step S10. Then, the feeding of fiber material remnants follows in step S11. These may be, e.g., mat remnants or fabric remnants of carbon fiber fabrics or carbon fiber mats. Herein, it is possible at first to carry out a manual sorting or classifying in order to produce semifinished fiber material that is as uniform as possible.

Cutting of the fiber material remnants, for example, into flat pieces of 10×10 cm size, then follows in step S12. This may be done, for example, with a cutting roller.

If necessary, a separation of the flat fibrous elements into individual fibers is carried out in step S13. This may be done, for example, by means of vibration. As a result of this, an unraveling of the fiber ends is largely avoided.

The fibrous elements or fibers are then aligned, for example, by means of a vibration conveyor in step S14 and then applied to a carrier material in step S15. Thermoplastic carrier materials in a flat design are used as carrier material, whereby the thermoplastic carrier material is fluid-permeable, especially permeable for duroplastic matrix material.

A fixing of the fiber material to the carrier material, for example, by means of a suitable compressed section is carried out in step S16. Checking whether a lamination shall be carried out follows in step S17 as the next thing to do. If this is not the case, the semifinished fiber material is stored and the process ends in step S21. If it is determined in step S17 that a lamination shall be carried out, the necessary build-up of layers first follows in step S18. Herein, the semifinished fiber material can be arranged in the known manner in layers one on top of the other with predetermined orientation.

The prepared layers of semifinished fiber material are then impregnated with a suitable duroplastic matrix material in step S19. Consolidation then follows in step S20. This can be carried out in the known manner with a roller under vacuum or in an autoclave. Then, in step S17, it is checked whether the lamination shall be continued. If this is the case, it continues in step S18. As soon as it is determined in step S17 that lamination shall not be further carried out, the process ends in step S21 as the next thing.

With the process described and devices described, it is possible to prepare fibers coming especially from waste remnants, especially carbon fibers as long fibers, i.e., with a length of more than 1 mm, in a simple and cost-effective manner and in an oriented manner as semifinished fiber material that is stable when stored. The slight worsening of the strength of the finished duroplastic fiber-reinforced plastic can be accepted, since there are considerable cost savings with the process. In this way, simple and cost-effective, high-quality carbon fiber material may also be used for those components, for which this expensive fiber raw material would actually be too expensive. There is considerable demand for this especially for automotive applications.

While specific embodiments of the invention have been shown and described in detail to illustrate the application of the principles of the invention, it will be understood that the invention may be embodied otherwise without departing from such principles.

### LIST OF REFERENCE NUMBERS

10 Device
11 Vibration conveyor
12 Vibration conveyor
13 Extruder
14 Carrier material
15 Compressed section
16 Roller
17 Roller
18 Roller
19 Semifinished fiber material
20 Roll
21 Device
22 Vibration conveyor
23 Fibrous elements
24 Conveyor belt
25 Carrier material
26 Roll
27 Double belt press

What is claimed is:

1. A process for producing semifinished fiber material with oriented fibers, the process comprising:
providing a flat carrier material;
depositing fibers aligned on the carrier material;
fixing the fibers to the carrier material;
providing the carrier material as a fluid-permeable carrier material made of a thermoplastic.

2. A process in accordance with claim 1, wherein the carrier material is a nonwoven fabric, a mat or a fabric.

3. A process in accordance with claim 2, wherein the carrier material is made of one or more of polypropylene and polyamide.

4. A process in accordance with claim 1, wherein carbon fibers are used as the fibers, which are arranged edge to edge and overlap by a predetermined extent in a fiber direction.

5. A process in accordance with claim 1, wherein alignment of the fibers is carried out by means of a vibration conveyor having an upwards directed vibration conveying path.

6. A process in accordance with claim 1, wherein the aligned fibers are conveyed to the carrier material by means of a conveyor belt as a flat arrangement and/or are deposited on the carrier material, whereby the conveyor belt is applied with a vacuum for the nonslip conveying of the fibers, the vacuum decreasing in a direction of conveying.

7. A process in accordance with claim 1, wherein the fibers are fixed to the carrier material by means of a double belt press, a pair of rollers, a calendar, parallel compacted sheets and/or an adhesive film on the carrier material.

8. A process in accordance with claim 1, wherein:
the fibers comprise waste remnants of a nonwoven fabric, a mat or a fabric;
the fibers are cut into flat pieces; and
the fibers are separated by means of vibration.

9. A device for producing semifinished fiber material with oriented fibers, the device comprising:
an alignment section for aligning the fibers; and
an application section for applying the oriented fibers onto a carrier material, wherein the alignment section has an upwards oriented vibration conveyor.

10. A device in accordance with claim 9, further comprising a conveyor belt for conveying the aligned fibers as a flat arrangement to the carrier material, whereby the conveyor belt has a vacuum unit, which applies a vacuum which decreases down to ambient pressure in a downstream direction of the conveyor belt.

11. A device in accordance with claim 9, further comprising a feed means for feeding the carrier material from a supply to the fibers.

12. A device in accordance with claim 9, wherein the application section comprises a double belt press, a calender or a pair of rollers for fixing the fibers to the carrier material.

13. A device in accordance with claim 9, further comprising a cutting means comprising a cutting roller, and/or fibers separating means separating fibers by means of vibration.

14. A semifinished fiber material with oriented fibers, wherein the oriented fibers are arranged on a fluid-permeable carrier material made of a thermoplastic material.

15. A semifinished fiber material in accordance with claim 13, wherein the carrier material is a nonwoven fabric mat or fabric and the carrier is made of one or more of polypropylene and polyamide.

16. A semifinished fiber material in accordance with claim 14, wherein the fibers are carbon fibers comprising waste remnants in the form of surface elements.
